(19) United States
(12) Patent Application Publication
(10) Pub. No.: US 2009/0007467 A1
(43) Pub. Date: Jan. 8, 2009

(54) Advent-Type Calendar Container Frame and Methods for Assembly

(75) Inventor: Linden H. Bowman, Ellicott City, MD (US)

Correspondence Address: CAHN & SAMUELS LLP, 1100 17th STREET NW, SUITE 401, WASHINGTON, DC, 20036, US

(73) Assignee: THE LINDY BOWMAN COMPANY, Elkridge, MD (US)

(21) Appl. No.: 11/773,796

(22) Filed: Jul. 5, 2007

(51) Int. Cl. G09D 3/06

(52) U.S. Cl. 40/107

(57) ABSTRACT

An advent-type calendar with a plurality of chambers holding a plurality of containers each container receiving a gift item and corresponding to a time period (a day, for example) of an occasion. The containers are successively removed and opened to reveal the gift item, then rotated and replaced into the chamber to indicate that the corresponding time period has been achieved or surpassed and the container has been used or emptied.

### I. FIELD OF THE INVENTION

This invention relates to improvements to the traditional advent-type calendar and more particularly to an enhanced advent-type calendar comprising a plurality of chambers each having a container for holding a gift item wherein the containers are removable and re-orientable and preferably having external surfaces with distinguishing indicia such that the container can be removed, rotated, and replaced into its associated chamber to indicate that a particular time period (e.g., a day) of an occasion (e.g., an event or holiday) has been achieved or surpassed.

### II. BACKGROUND OF THE INVENTION

Conventional advent-type calendars are used to count down the days before Christmas. Such calendars include a plurality of flaps or chamber coverings, each being associated with a particular day during Advent. On the specified day, a user opens the designated flap to reveal either a picture or message underlying the flap, on the obverse of the flap, or both, or an underlying physical object such as candy. Generally, such Advent calendars are directed toward children with the purpose of providing a daily experience of surprise.

Typically, a calendar's flaps are opened by pivoting and, once opened, are either left open or physically removed. Manipulation and/or removal of flaps can be cumbersome, and flaps may not be uniformly opened and/or removed, thereby resulting in an unattractive, irregular or cluttered appearance. Other, less-typical calendar structures incorporate sliding screens or drawers. Although these less-typical structures permit reclosure, confusion may result as to the correct screen or drawer in the sequence to open on a particular day.

In the case of traditional chambered calendars, each chamber is typically adapted to contain a select single item, e.g., a picture, candy, memento or toy that is revealed upon opening the chamber, and the chamber is thereafter rendered no longer useful.

Some calendars contain pre-printed text or advertising, for example on the obverse of the chamber flap. However, when placed on the obverse of the flap, a picture or writing can be viewed only while the flap is open. As noted above, a less attractive appearance results when a number of the calendar flaps remain in open, but non-uniform, positions, which tends to create a cluttered appearance. While obviating the problem of non-uniform flaps, reliance on sliding screens or drawers does not permit printing or graphics other than on the front surface of the screens or drawers and underlying the screens or drawers once they are opened or removed.

The chambers comprising traditional advent-type calendars are typically presented within a single coherent overall picture or design, for example, a Christmas tree (see UK Patent Application no. GB2300563A—withdrawn), one of several pets (see US Patent Application no. US 2003/0163936A1), or a single photograph of a male or female model or a single funny cartoon caption (see UK Patent Application no. GB 2328762A). Ordinarily, the overall pictures or designs do not change. These advent-type calendar are created for one particular purpose, event or holiday (for example, Christmas, pets, or adult items). Thus, the typical advent-type calendar cannot be reused except on the same holiday or event and only using the same static overall picture or design.

Notwithstanding the usefulness of the above-described structures typically used with the advent-type calendar, a need still exists for a convenient and aesthetically pleasing way to indicate that a particular time period (e.g., a day) of an occasion (e.g., an event or holiday) has been achieved or surpassed and which of the corresponding containers have been used or emptied. A need also exists for an integrated calendar wherein each container provides several benefits including: 1) a user-selected, removable object and 2) indicia on its exterior surface, including personalized or educational writings, whereby such indicia might combine with indicia on other containers to form one or several coherent visible images, and whereby the plurality of indicia on each container allows the calendar to be reused with a different appearance.

### III. SUMMARY OF THE INVENTION

It is an object of at least one embodiment of the invention to overcome the foregoing exemplary shortcomings and problems with the prior art.

It is another object of the invention to provide an advent-type calendar that is emotionally satisfying and decorative.

It is a further object of at least one embodiment of the invention to provide an advent-type calendar that allows the user to count the time periods comprising a particular occasion in a simple, pleasing, and aesthetic manner.

It is an object of at least one embodiment of the invention to access the chamber by way of a container, rather than a flap, screen, or drawer, the container having a plurality of exterior surfaces with distinctive indicia and being easily rotated to indicate that a particular time period (e.g., a day) of an occasion (e.g., an event or holiday) has been achieved or surpassed and that the container has been used or emptied of its gift item.

It is an object of at least one embodiment of the invention to provide a calendar capable of being reused, thereby providing additional utility and cost savings (recyclability). Reuse of the calendar also allows the user to choose the nature and content of items placed into the containers, such as candy or toys, which fosters creativity, individuality, and personal choice.

Yet a further object of at least one embodiment is to use the exterior surfaces of the container for indicia including writings (including educational) or graphic designs, thereby providing such designs or writings in addition to the traditional removable toy or candy. The invention, therefore, can be used for a variety of entertainment, educational, and aesthetic purposes.

It is still a further object of at least one embodiment of this invention to permit user-customizing of the exterior surfaces of the container using, for example, a personalized message or photograph. A calendar with this capacity also cultivates creativity and provides a personal touch.

Another object of at least one embodiment of the invention is to allow collective viewing of indicia on the exterior surfaces of a plurality of containers to display a coherent visible image. Each container is a geometric solid possessing a plurality of external surfaces, thereby allowing for exhibition of several designs. The designs on each of the select containers can be viewed in combination to reveal a single overall design for the calendar. The plurality of indicia also allows the calendar to be reused for several of the same or different occasions. Also, a single chamber frame neutral in color and texture can also be used with different sets of containers corresponding, for example to different occasions (such as Christmas, Halloween, Easter, birthdays, anniversaries, graduation, etc.).

In one embodiment of the invention the advent-type calendar includes a three-dimensional frame with a divider that divides the frame into a plurality of chambers. A container corresponds to each of the chambers in the frame. The containers have a compartment for holding gift items and are capable of being removed, rotated, and re-nested inside their corresponding chambers. The containers have an exterior surface which can bear indicia (e.g., graphics or writings) used for a variety of purposes. In one embodiment, indicia on the containers identify a succession of time periods (days, for example) making up a particular occasion. Other embodiments may contemplate a succession of particular events (for example, successive sporting events or school years) or milestones (walking, talking, and toilet training, for example).

In another embodiment, the invention comprises a process to use the advent-type calendar such that the time periods of an occasion are counted by consecutively removing, rotating and re-nesting each container into its corresponding chamber. While the container is removed from the chamber, the gift item can be removed from the container's compartment. Rotating the container causes a second indicia to be displayed, thereby indicating that the time period has been achieved or surpassed and that the container has been emptied of its gift item.

In a further embodiment, indicia on each container contain a portion of a coherent visible image, and the entire coherent visible image is revealed by viewing indicia on all of the containers in combination.

As used herein, “advent-type calendar” refers to a structure containing a plurality of chambers, each chamber corresponding to and consecutively recognizing a select and discrete time period, a plurality of such time periods comprising an occasion. The chambers are adapted to receive and contain a gift item to be revealed during the corresponding time period. Although Advent calendars are typically used to count off the days before Christmas during the Advent season, the term “advent-type calendar” as used herein is not limited to the Christmas holiday.

As used herein, “occasion” means a holiday, event, celebration, anniversary, or milestone or a combination of such occasions (for example, the combination of Advent, Christmas and the New Year).

As used herein, “time period” generally refers to a select and discrete measure of time, e.g., a day, week, or month, to a specific event in a sequence of associated events, or to a portion of an occasion, including those occurring prior to and during the occasion.

As used herein, “container” refers to a box, receptacle, enclosure or other device used to hold a gift item.

As used herein, “gift item” refers to a picture, momento, writing, candy, small toy, coupon, advertisement or other special object, item or gift.

As used herein, “indicia” refers to a depiction including printed, handwritten, pictorial, graphic, photographic, numerical, artistic, literary, personalized, or educational matter, including neutrals and blanks, and also including indications of select time periods.

As used herein, “coherent visible image” refers to a depiction including printed, handwritten, pictorial, graphic, photographic, numerical, artistic, literary, personalized, or educational matter, including a combination of such depictions with a unified theme.

As used herein, “substantially,” “generally,” “relatively” and other words of degree are relative modifiers intended to indicate permissible variation from the characteristic so modified. They are not intended to be limited to the absolute value or characteristic which they modify, but rather possessing more of the physical or functional characteristic than its opposite, and preferably approaching or approximating such a physical or functional characteristic.

In the following enabling description, reference is made to the accompanying drawings which are shown by way of illustration of the specific embodiments in which the invention may be practiced. In the following embodiments the apparatus should become evident to a person of ordinary skill in the art and in sufficient detail to enable those skilled in the art to practice the invention. It is to be understood that other embodiments may be used and that structural changes based on presently known structural and/or functional equivalents may be made without departing from the scope of the invention.

### IV. BRIEF DESCRIPTION OF THE DRAWINGS

FIG. 1 depicts a top view of an embodiment of the invention with indicia on the containers forming a coherent visible image of Santa Claus.

FIG. 2A depicts a perspective view of a chamber frame and divider establishing an array of chambers.

FIG. 2B depicts a perspective view of the frame, divider and chambers illustrated in FIG. 2A.

FIG. 3 illustrates the container-retaining surface of the frame with flanges.

FIG. 4A illustrates an embodiment of the base of a cubical container.

FIG. 4B depicts an inverted cubical container lid corresponding to the base illustrated in FIG. 4A.

FIG. 5 is an assembly view of the container embodiment illustrated in FIGS. 4A and 4B.

FIG. 6 depicts the container embodiment illustrated in FIG. 5 in the partially assembled position, illustrating the telescoping of the lid and base of the container.

FIG. 7 depicts a perspective view of the container embodiment illustrated in FIG. 5 and FIG. 6. The container base and lid are in a seated position.

FIG. 8 depicts an embodiment of the base of a cubical container with a pair of co-acting folding lid flaps.

FIG. 9 depicts an embodiment of a cubical container without a lid.

FIG. 10 depicts an assembly view of an embodiment of the invention with a container partially removed from its chamber.

FIG. 11 depicts the embodiment illustrated in FIG. 10 after removal from the chamber, rotation and reinsertion into the chamber.

FIG. 12 depicts a cubical container incorporating selected indicia on its exterior surface.

FIG. 13 depicts a cubical container incorporating selected indicia on its exterior surface. Indicia on the top of the container includes a portion of the coherent visible image of Santa Claus illustrated in FIG. 1.

FIG. 14 depicts a cubical container with handwritten writings and drawings.

FIG. 15 depicts an embodiment of the invention with all of the containers inside the chamber frame and indicia on the exterior surfaces of the containers revealing a coherent visible image comprising a personal photograph.

FIG. 16 depicts a circular frame in the shape of an engagement ring with the containers removed and a divider forming pie-slice shaped chambers. The back side surface of the frame reveals a wedding cake scene.

FIG. 17 depicts an assembly view of a pie-slice shaped container corresponding to the embodiment illustrated in FIG. 16.

FIG. 18 depicts a combined structure including four (4) frames forming the sides of a cube. The containers are removed from the chambers.

FIG. 19 depicts an inverted cubical container lid corresponding to the base illustrated in FIG. 4A featuring a Christmas tree ornament as the gift.

FIG. 20 depicts a embodiment of the invention where the gifts are Christmas tree ornaments displayed on a Christmas tree.

FIG. 21 depicts an assembly view of the Christmas tree embodiment of FIG. 20.

### V. DETAILED DESCRIPTION OF THE INVENTION

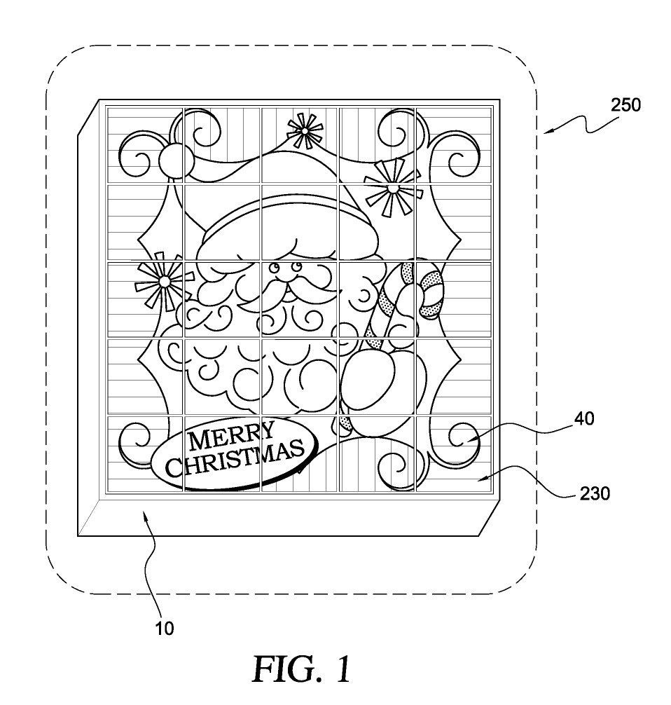

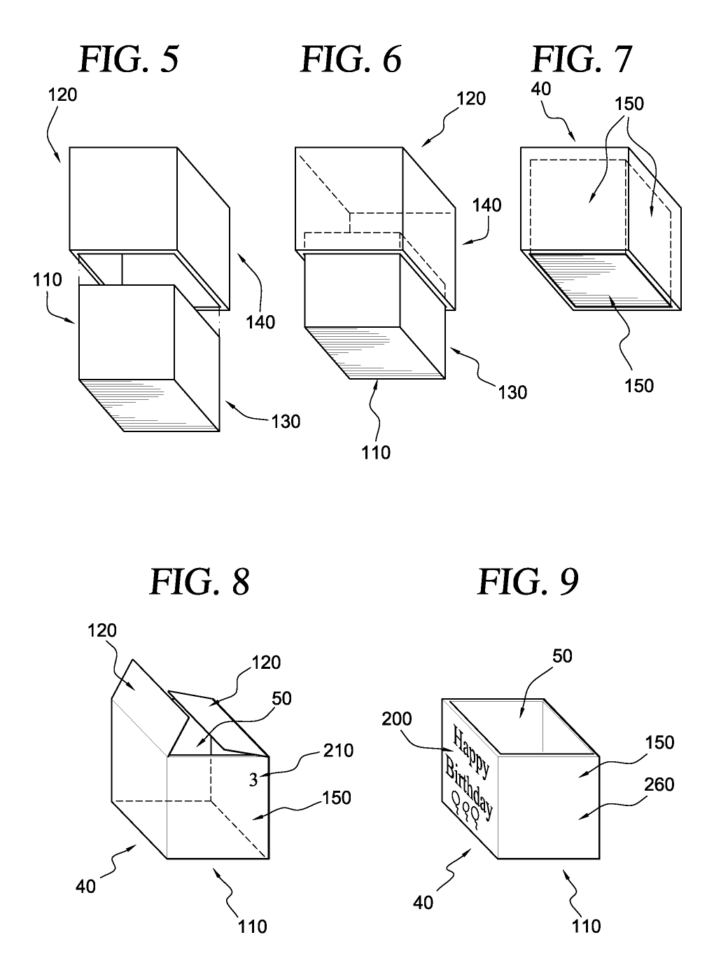

The present invention is generally directed to improvements to the advent-type calendar and methods of manufacturing, assembling and using the same. An advent-type calendar in accordance with one embodiment, illustrated in FIGS. 1, 2A, 2B, 10 and 11 comprises a three-dimensional frame 10 and a divider 20. The divider 20 divides the frame 10 into a plurality of chambers 30. A plurality of containers 40 correspond to and nest within each of the chambers 30 (see FIGS. 5, 6, and 7). Each of the containers 40 includes a compartment 50 for receiving and retaining a gift item 60. The container 40 can be removed from the chamber 30 and opened to reveal the gift item 60. Once the gift item 60 is removed from the compartment 50, the container 40 can be re-inserted into the chamber 30.

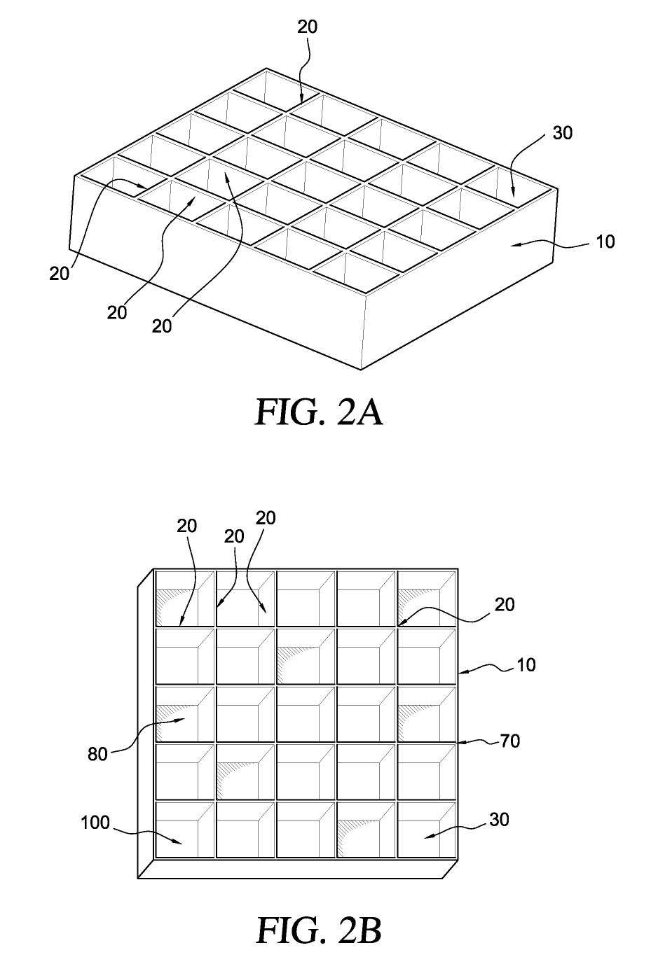

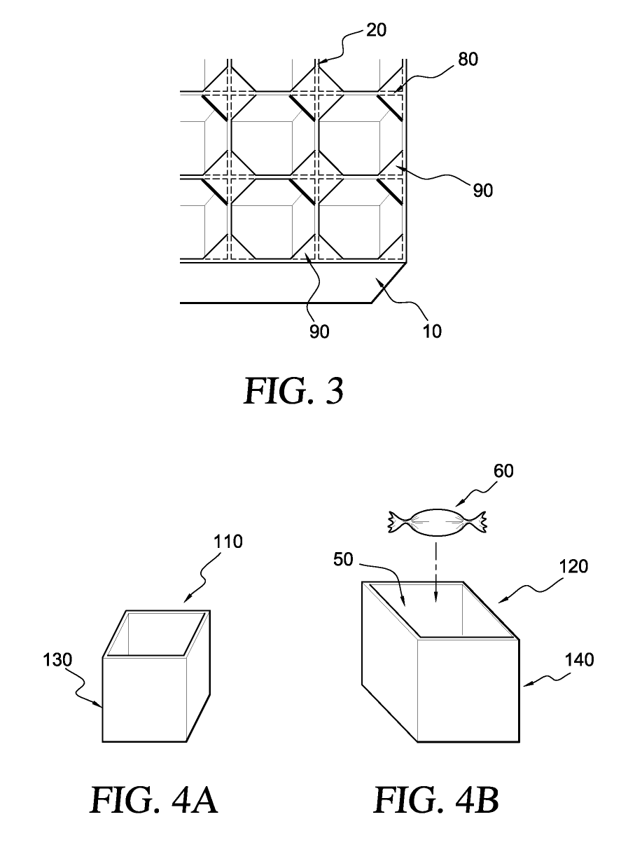

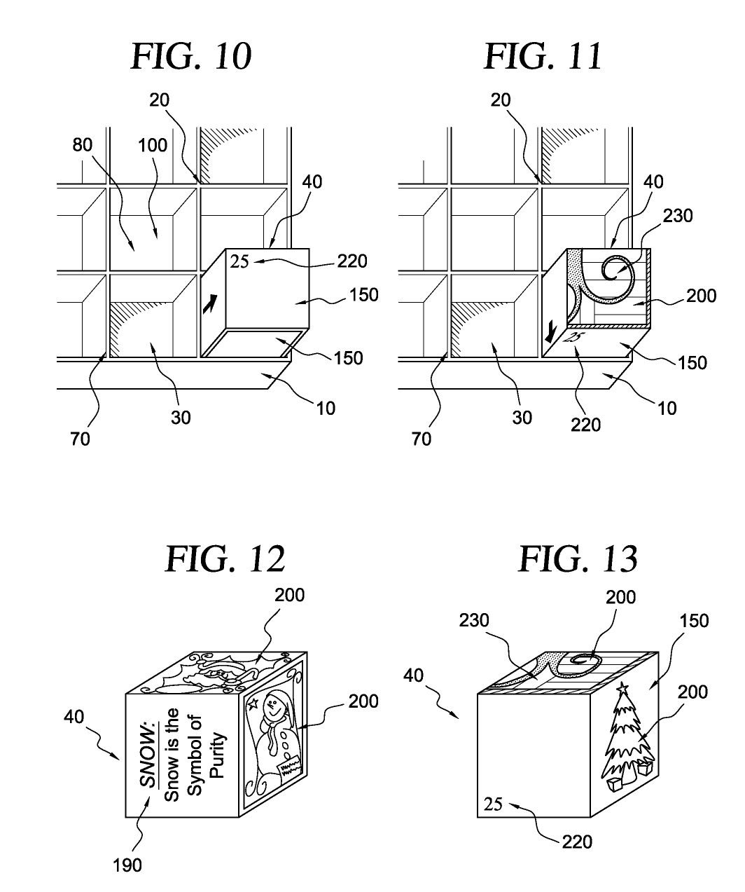

In the embodiment illustrated in FIGS. 1, and 2A, 2B the invention is comprised of a square frame 10 and a divider 20 forming twenty-five (25) chambers 30 arranged in rows and columns on a five-by-five grid. Each of the twenty-five (25) chambers 30, holds one of twenty-five corresponding containers 40. The chambers 30 are generally cubical, that is, each is of equal width, length and depth. As illustrated in FIGS. 10 and 11 a container 40 is capable of being nested within each of the chambers 30. The containers 40 are dimensionally complementary (generally cubical) and preferably slightly smaller than the chambers 30, thereby allowing the containers 40 to be snuggly inserted and removed from the frame 10 while fitting neatly and securely inside the chambers 30.

According to the invention, the frame 10 is three-dimensional and has a front side 70 and a back side 80. The containers 40 are inserted into the front side 70 and are retained in the frame 10 by the back side 80. In one embodiment, the back side 80 retains the containers by way of flanges 90 attached to the edges of the divider 20. In another embodiment the back side 80 is a planar surface 100. FIG. 16 illustrates a wedding scene depicted on a planar surface 100 back side 80 of the frame 10.

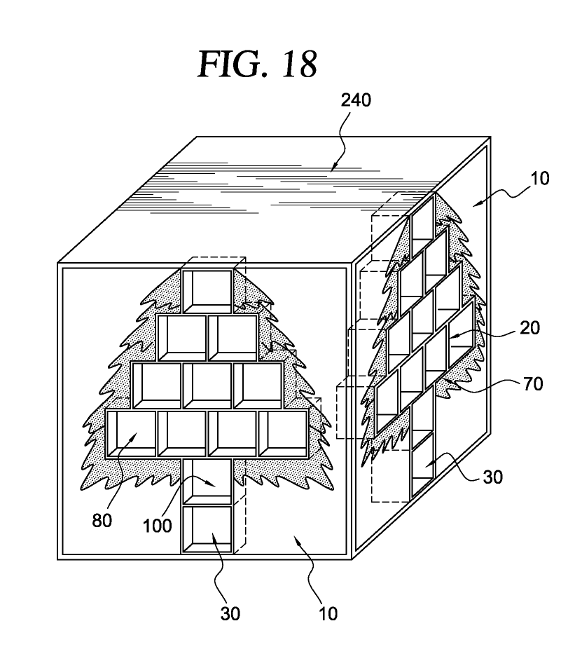

The divider 20 divides the frame 10 into a plurality of chambers 30. The chambers 30 can be uniform in dimension or in any other shape formed by the divider 20. FIGS. 2A, 2B, 10, and 11 Illustrate cubical chambers 30, while FIGS. 16 and 17 illustrate chambers 30 in the shape of a slice of pie.

The containers 40 are dimensioned to nest within the chambers 30. Each container 40, therefore, is generally dimensioned to the shape of its corresponding chamber 30. In the embodiment illustrated in FIGS. 2A, 2B, 10 and 11, the chambers 30 are cubical and the containers 40 are also cubical. In the embodiment illustrated in FIGS. 16 and 17, both the chambers 30 and the containers 40 are in the shape of a pie-slice.

The containers 40 have a compartment 50 for receiving and retaining a gift item 60. In one embodiment, the container 40 includes a base 110. The base 110 can be in the shape of a box (a planar surface with a side wall 130 along its perimeter). FIGS. 4A, 8, and 9 illustrate cubical, box-shaped bases 110. FIG. 17 depicts a pie-shaped box base 110.

In one embodiment, the container 40 has no lid 120 (FIG. 9), or the container 40 can include a lid 120. In several illustrated embodiments the lid 120 generally conforms to the dimensions of the base 110 and also comprises a planar surface with a side wall 140 as illustrated in FIG. 4B. In the embodiment illustrated in FIGS. 4A, 4B, 5, 6, and 7, the side wall 140 of the lid 120 telescopically slides over and registers with the side wall 130 of the base 110. In another embodiment, the lid 120 is a pair of co-acting folding flaps made of two (2) planar members whose perimeters are hingedly attached to the side wall 130 of the base 110 (see FIG. 8).

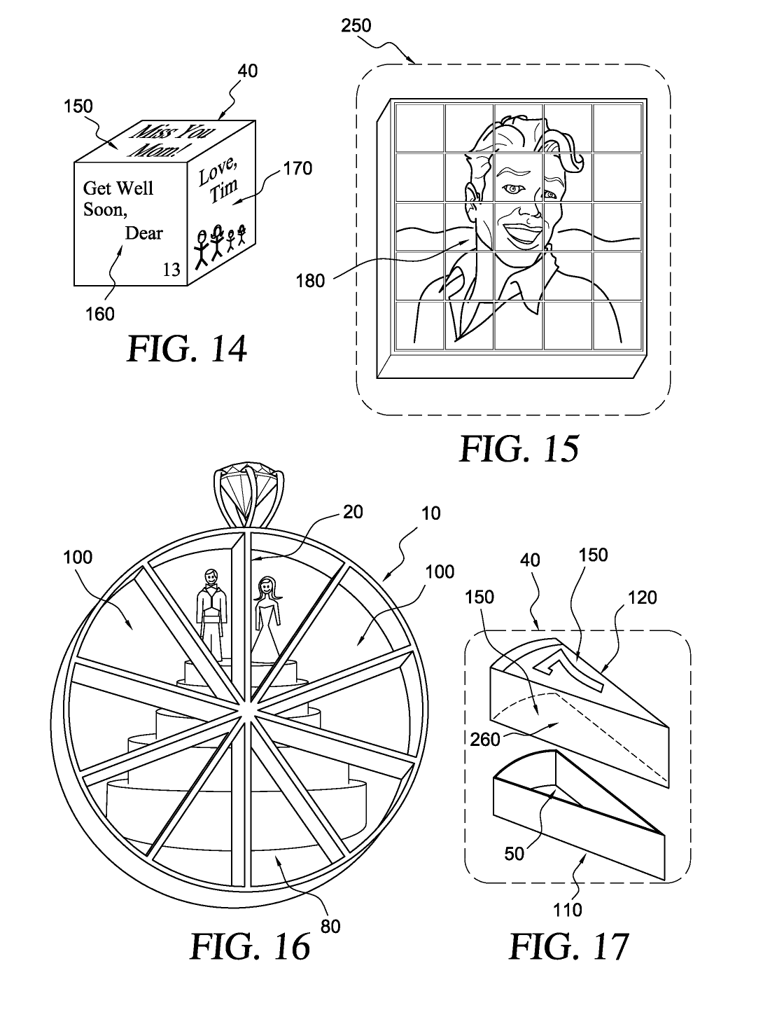

The containers 40 have an exterior surface 150 which is visibly exposed when the container 40 is nested in the chamber 30. In certain embodiments the exterior surface 150 of the container 40 bears indicia. In some embodiments, indicia include educational matter 190 (see FIG. 12) or printed images 200 (see FIGS. 12 and 13). In one embodiment, the exterior surface 150 of the container 40 is capable of receiving indicia in the form of handwriting 160 or a drawing 170. For example, the embodiment illustrated in FIG. 14 might be used to allow well-wishers to hand-write personal messages or draw pictures on the calendar containers 40 during an extended hospital stay. In another embodiment, the exterior surface 150 of the container 40 can receive a photographic image 180 (see FIG. 15). The exterior surface 150 can also be left blank/neutral 260 (FIG. 9). In still a further embodiment, the indicia is an indication 210 of the specific chamber 30 to which the container 40 corresponds (FIG. 8, 10, 14).

In one embodiment, indicia on the exterior surface 150 of a container 40 is an indication 220 of a select time period defining an occasion. For example, FIGS. 10 and 11 illustrate a container 40 bearing the number “25”, located in the twenty-fifth chamber 30 in a frame 10, and corresponding to Christmas day, the 25^{th} day of December. This embodiment is similar to traditional Advent calendars whereby a gift item 60 is removed from a different container 40 corresponding to each day of the Advent season.

According to the invention, the container 40 can nest within the chamber 30 in more than one position, and the exterior surface 150 of the container 40 can bear multiple indicia. Thus, in one embodiment, such as that illustrated in FIGS. 10 and 11, a container 40 corresponding to a particular day of Advent can be identified by a first indicia comprising an indication 220 of a day in the month of December (the 25^{th} of December). This first indicia is exposed while the container 40 is nested in the chamber 30. On the corresponding day, the container 40 can be removed from its chamber 30 and the gift item 60 removed. Thereafter, the container 40 can be rotated and reinserted into the chamber 30. Rotation of the container 40 indicates that the appropriate date has passed and that the corresponding container 30 is empty. As a result of rotating the container 40, a second indicia is exposed when the container 40 is re-inserted into the chamber 30. FIG. 10 illustrates the removal of a container 40 bearing indicia indicating the 25^{th} day of December. FIG. 11 illustrates the same container 40, after being rotated, being re-inserted into the same chamber 30, thereby exposing a second indicia comprising a printed image 200. According to an embodiment of the invention, the next sequential day, and the location of the next unemptied container 40, is determined by examining indicia on the container 40 to determine whether the first indicia (corresponding to an unused container 40) or second indicia (corresponding to a used container 40) is exposed.

Indicia on a container 40 can be a complete and self-contained image. For example, FIG. 12 shows both a snowman image and a Santa Claus image on the top and the side of the container 40. A Christmas tree image is the indicia on the side of the container 40 illustrated in FIG. 13. In other embodiments, indicia on several containers 40 present a single coherent visible image 250 when viewed collectively. For example, the printed image 200 indicia on the top of the container illustrated in FIG. 13 (see also FIG. 11) is a portion 23 of the coherent visual image 250 of Santa Claus illustrated in FIG. 1.

A coherent visual image 250 can include any number of printed 200, handwritten 160 170, pictorial, graphic, photographic 180, numerical, artistic, literary, personalized, or educational 190 matter. For example, FIG. 15 illustrates one embodiment wherein the coherent visual image 250 comprises a photograph 180. Portions 23 of the photograph 180 are the indicia on each of the containers 40. This embodiment might be used for an individual counting the days toward a promotion or a wedding picture of an elderly couple counting the weeks toward an anniversary.

The coherent visual image 250 can also be a combination of any of the matter identified above with a unified theme. For example, an embodiment might comprise a four-by-four frame 10 counting off the years before graduation from high school (at year twelve) and college (at year sixteen). Corresponding indicia on the exterior surfaces 150 of the first twelve (12) containers 40 form a coherent visible image 250 representative of high school graduation. Indicia on the last four (4) containers 40 form a different and distinct, yet complimentary, coherent visible image 250 symbolizing college graduation.

Because the containers 40 can bear several indicia, the invention is capable of being reused without displaying the same overall design. Numerous coherent visual images 250 on the same set of containers allow change to the overall appearance of the calendar when it is reused. The same set of containers 40, therefore, can be used for multiple or different occasions. For example, the same set of containers 40 might be used for Advent, Hanukkah, and Christmas.

Similarly, an entire set of containers 40 might be replaced, thereby allowing use of a completely different set of containers 40 with the same chamber 30 frame 10. For example, the same frame 10 might be used with different sets of containers 40 with themes for Christmas, Halloween, and birthday.

In another embodiment, illustrated in FIG. 18, several frames 10 are combined within a single combined structure 240. The sides of the combined structure 240 are defined by four (4) frames 10 arranged at ninety (90°) degree angles with the front side 70 of each frame 10 facing the exterior. In the illustrated embodiment, each frame 10 has twelve (12) chambers 30 which might correspond to each of the twelve (12) days of Christmas. This embodiment provides four (4) advent-type calendars at the same time for the same event, and might be used, for example, by a family of four or a family having four children.

In the embodiment illustrated in FIGS. 16 and 17, a circular frame 10 contains ten (10) pie-slice shaped chambers 30 in a wheel-shaped frame 10 with an overall design resembling an engagement ring. The corresponding containers 40 are pie-slice shaped (FIG. 17) and bear indicia numbers. The numbers might be used to count down (from ten to one) a time period (weeks or months) prior to a wedding. As each time period passes, a container 40 is removed from the frame 10, and a gift item 60 is removed from the container 40. The containers 40 are not replaced into the chambers 30, and the back side 80 of the frame contains a picture of a wedding cake with a bride and groom.

In another embodiment, the invention is comprised of thirty-five (35) chambers 30 in a five-by-seven frame 10. The first thirteen (13) containers 40 display the days of the month, and the fourteenth container 40 (illustrated in FIG. 9) says “Happy Birthday” (for an individual whose birthday falls on the fourteenth day of the month.) As containers are used, they are rotated to reveal a neutral/blank 260. If the birthdate falls later in the month, containers 40 corresponding to each day of the month can be rotated to reveal the date or the “Happy Birthday” indicia.

In another embodiment, a nine-by-nine frame 10 counts off the months before the expected birth of a child. Each of the containers 40 (illustrated in FIG. 8) comprises a cubical box with two folding flaps forming the lid 120. Each month, the expectant couple removes a gift item 60 from the container 40. The gift items 40 might include a scroll with written words of religious encouragement, medical advice or coupons to baby stores. Before the container 40 is replaced into the frame 10, the expectant couple or their relatives place a $100 bill into the compartment 50 of the container 40 to save for the anticipated expenses of childbirth.

The invention also comprises processes for assembling the advent-type calendar. A process embodiment comprises the step of inserting the container 40 into its corresponding chamber 30. Another process embodiment comprises further inserting the gift item into the compartment 50 of the container 40.

Yet a further process embodiment comprises the following additional steps. First, a container 40 is identified having a first indicia (for example, an indication 220 of a time period defining an occasion) that is exposed while the container 40 is nested in the chamber 30. The container 40 is removed, as illustrated in FIG. 10, and is rotated and re-inserted into the same chamber 30, as illustrated in FIG. 11. Rotation of the container 40 results in a second indicia being visibly exposed after the container 40 is re-inserted. This process allows a user to identify which containers 40 have been emptied or used and to identify the next container 40 in a sequence (for example a sequence of time periods comprising an occasion).

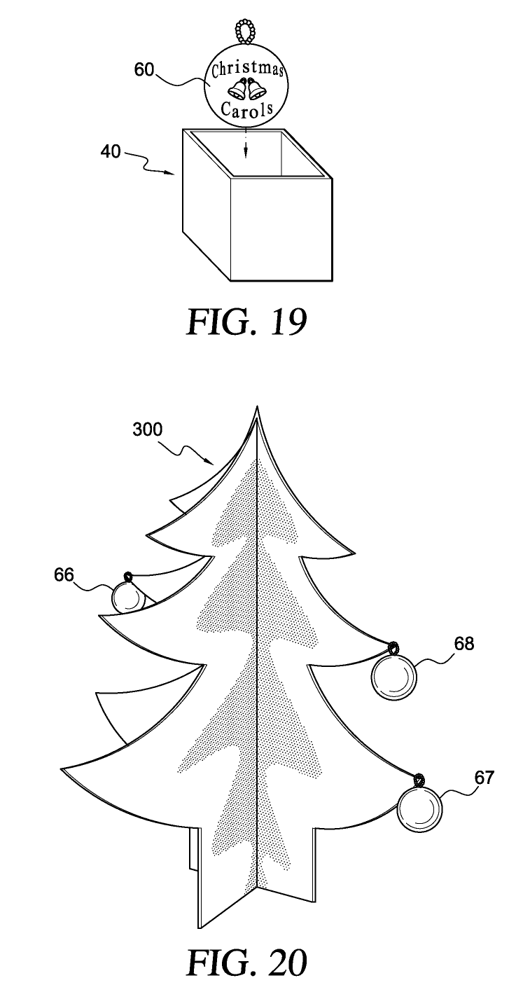

In yet another embodiment, each frame 10 has (12) chambers 30 which might retain containers 40 that correspond to each of the twelve (12) days, twenty-four (24) days, or a selected number of days preceding Christmas. As illustrated in FIG. 19, gift item 60 is a Christmas tree ornament featuring indicia corresponding to a particular day of the Advent season or day preceding Christmas. As illustrated in FIG. 20, in addition to the Christmas tree ornaments 66 this embodiment may further comprise a representation of a Christmas tree 300 with branches configured hold or otherwise display the Christmas tree ornaments 66, 67, 68. Each day an ornament may be removed from a container 40 and displayed on Christmas tree 300 as shown in FIG. 20.

Christmas tree 300 features a structure that allows for quick and easy assembly or disassembly via the use of two or more interlocking flat panels, folding panels, pull out or accordion structure, a combination thereof, or other structure that allows the Christmas tree to be stored in a flat package when not in use. This feature allows the packaging of the Christmas tree to be optimized to avoid significant, additional, packaging demands or additional space demands relating to subsequent storage or shipping of this embodiment.

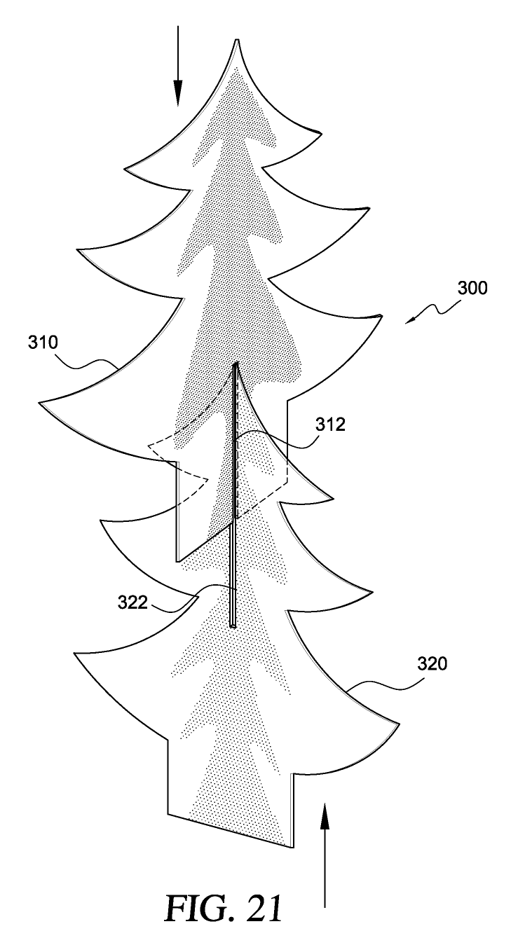

FIG. 21. shows an example embodiment of the Christmas tree 300 constructed from interlocking flat panels 310 and 320. Panel 310 features a coupling groove 312 at the bottom of the panel and panel 320 features a coupling groove 322 at the top of the panel. As shown in the figure panels 310 and 320 are assembled by sliding the flat panels together along the coupling groove to create a free standing Christmas tree. The assembled Christmas tree 300 can be easily disassembled and stored as a flat structure.

Clearly, the invention provides an advent-type calendar with the ability to conveniently and aesthetically indicate which of a plurality of containers 40 have previously been used or emptied and with the integrated ability to provide for each container 40: 1) a removable gift item 60, 2) writing 160 170, printing, or an educational component 190, and 3) one of several printed images 200 on the exterior surface 150 of the container 40 which, when viewed collectively, form one of several coherent visible images 250.

Variations of the above-described combinations and methods are intended to fall within the scope and spirit of the invention. For example, the calendar might be capable of counting days, weeks or months. These can be counted before, during or after a particular date or time period. By way of further example, the calendar can be one or a plurality of frames 10. The frames 10 can be a specific or a neutral color. Chambers 30 and their respective containers 40 can be the same or different shapes and each can take the shape of a cube, a rectangle, a pie-slice or any other three-dimensional geometric form. The chambers 30 can also be empty and not have a corresponding container 40. Further variations include containers 40 opening telescopically (FIGS. 5, 6, and 7), by single-flap or double-flap (FIG. 8) lids 120, or by way of removing a lid-less container 40 (FIG. 9) from its chamber 30. Variations also include different numbers, configurations shapes and sizes of chambers 30 and containers 40. Different configurations of one or a plurality of chamber 30 frames 10 are possible within a combined structure 240 (FIG. 18). Other variations include different writings and indicia on the tops, bottoms, sides, fronts, and backs of the chambers 30 and containers 40. Indicia can be printed 200, hand-written 160 170 or the exterior surface 150 of the container 40 can be left neutral/blank 260. By way of further example of variations, collective indicia on the chambers 30 and containers 40 can form a single coherent visible image 250 or a plurality of the same, all within the same frame 10 or within different frames 10 within a combined structure 240.

Given the foregoing, it should be apparent that the specifically described embodiments are illustrative and not intended to be limiting. Furthermore, variations and modifications to the invention should now be apparent to a person having ordinary skill in the art. These variations and modifications are intended to fall within the scope and spirit of the invention as defined by the following claims.

I claim:

1. An advent-type calendar comprising:
a frame defining a first height dimension, a second width dimension and a third depth dimension, said frame also defining front and back surfaces,
a divider defining a plurality of chambers of select height, width, and depth dimensions within said frame, and
a plurality of containers each corresponding to said plurality of chambers wherein at least one of each of said containers corresponds to and is nestable within a select one of said plurality of chambers, each of said containers defining a compartment for receiving and retaining a gift item and an exterior surface visibly exposed when said container is nested in said chamber;
wherein said back surface of said frame is capable of retaining said plurality of containers in said plurality of chambers.

2. The advent-type calendar according to claim 1 wherein said back surface of said frame is a planar surface.

3. The advent-type calendar according to claim 1 wherein boundary flanges are integrally formed along the edges of said divider on said back surface of said frame.

4. The advent-type calendar according to claim 1 wherein said container is dimensioned to nest in at least one select of multiple positions within said select one of said plurality of chambers.

5. The advent-type calendar according to claim 1 wherein at least one of said plurality of containers includes:
a base of select planar dimensions comprising an upper surface with a perimeter edge and a side wall of a first height projecting substantially orthogonally from said perimeter edge; and
a lid for said container compartment.

6. The advent-type calendar according to claim 5 wherein said container lid generally conforms to said dimensions of said container base, said lid comprising a side wall of said first height dimensioned to slide over and register with said container base side wall.

7. The advent-type calendar according to claim 5 wherein said container lid comprises at least one planar member with a perimeter edge hingedly formed with said side wall of said container base.

8. The advent-type calendar according to claim 1 wherein said exterior surface of said container is capable of receiving indicia comprising at least one of a group consisting of drawing, handwriting, and photographic image.

9. The advent-type calendar according to claim 1 wherein said container exterior surface bears indicia including at least one of a group consisting of printed material, graphic designs, graphic pictures, numeric symbols, art, literary matter, educational matter, and indications of select discrete events.

10. The advent-type calendar according to claim 1 wherein said exterior surface on each of a select one of said plurality of containers bears indicia corresponding to each of a select one of said plurality of chambers.

11. The advent-type calendar according to claim 1 wherein said exposed exterior surface includes indicia referring to a select time period defining an occasion.

12. The advent-type calendar according to claim 1 wherein said exterior surface of said container bears a first and second indicia, said first indicia refers to a select time period defining an occasion, and said container is capable of visibly exposing said first indicia while nesting within said chamber and capable of being removed from said chamber, rotated, and re-nested within said chamber to visibly expose said second indicia.

13. The advent-type calendar according to claim 1 wherein said indicia on a first of said plurality of containers in combination with indicia on at least a second of said plurality of containers establishes a coherent image.

14. The advent-type calendar according to claim 13 wherein said indicia on said plurality of containers, in combination, establish a coherent visible image.

15. A combined structure including a plurality of advent-type calendars according to claim 1 assembled into a coherent structure.

16. An advent-type calendar comprising:
a frame defining a first height dimension, a second width dimension and a third depth dimension, said frame also defining front and back surfaces,
a divider defining a plurality of chambers of select height, width, and depth dimensions within said frame, and
a plurality of containers corresponding to said plurality of chambers where at least one of each of said containers correspondings to and is nestable within a select one of said plurality of chambers, each of said containers defining a compartment for receiving and retaining a gift item and an exterior surface visibly exposed when said container is nested in said chamber;
wherein said back surface of said frame is a planar surface capable of retaining said plurality of containers in said plurality of chambers;
each of said plurality of containers including:
a base of select planar dimensions comprising an upper surface with a perimeter edge and a side wall of a first height projecting substantially orthogonally from said perimeter edge, and
a lid for said container compartment generally conforming to said dimensions of said container base, said lid comprising a side wall of said first height dimensioned to slide over and register with said container base side wall;
said exterior surface of each of said plurality of containers bears three indicia wherein:
said first indicia refers to a select time period defining an occasion, said second indicia includes an educational writing related to said occasion, and
said third indicia on each of said plurality of containers, in combination, establish a coherent visible image related to said occasion; and
said container is capable of visibly exposing said first indicia while nesting within said chamber and capable of being removed from said chamber, rotated, and re-nested within said chamber to visibly expose any of the group consisting of said second, third and fourth indicia.

17. A process for assembling an advent-type calendar, said advent-type calendar comprising a plurality of chambers, and a plurality of containers, each container defining a compartment for receiving and retaining a gift item and an exterior surface bearing indicia visibly exposed when said container is nested in said chamber, said process comprising the step of inserting a select one of said containers into a select one of said chambers dimensionally corresponding to said select container.

18. A process for assembling an advent-type calendar, as recited in claim 17, said process further including the step of inserting a gift item into said compartment of at least one of said containers.

19. A process for assembling an advent-type calendar, as recited in claim 17, wherein each of said containers is dimensioned to nest in multiple positions within said select chamber, said exterior surface of said container bearing a first and second indicia, said first indicia referring to a discrete event defining an occasion, said process further comprising the steps of:
a. removing a select one of said plurality of containers with said first indicia visibly exposed,
b. rotating said container, and
c. re-inserting said container into said corresponding chamber to visibly expose said second indicia.
